(19) United States
(12) Patent Application Publication
(10) Pub. No.: US 2009/0064684 A1
(43) Pub. Date: Mar. 12, 2009

(54) Systems Involving Inlet-Mounted Engine Controls

(75) Inventor: Thomas G. Cloft, Glastonbury, CT (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: UNITED TECHNOLOGIES CORP., East Hartford, CT (US)

(21) Appl. No.: 11/777,483

(22) Filed: Jul. 13, 2007

(51) Int. Cl. F02C 7/20

(52) U.S. Cl. 60/796

(57) ABSTRACT

Systems involving inlet-mounted engine control components are provided. A representative system includes: a forward keep out zone defined by converging inner and outer walls of a nacelle; an aft keep out zone defined by a containment zone; and an engine control component, at least a portion of which is located between the forward keep out zone and the aft keep out zone, and between the inner and outer walls of the nacelle.

### BACKGROUND

1. Technical Field

The disclosure generally relates to gas turbine engines.

2. Description of the Related Art

Modern gas turbine engines typically incorporate an Electronic Engine Control (EEC), also referred to as a Full Authority Digital Engine Control (FADEC), for controlling engine functions. In this regard, an EEC functions as a primary interface between the gas turbine engine and an aircraft to which the engine is attached. By way of example, an EEC can receive thrust commands from thrust lever resolvers and can alter operating parameters of the engine responsive to those thrust commands.

Oftentimes, an EEC is configured as a line replaceable unit (LRU) that can be removed from an aircraft and replaced by ground maintenance personnel. Access to an EEC, such as for removal and replacement, typically is provided by an access panel that is located on the engine nacelle. Notably, such an EEC typically is mounted to the engine fan case aft of a fan blade containment zone for turbofan engines.

### SUMMARY

Systems involving inlet-mounted engine control components are provided. In this regard, an exemplary embodiment of such a system comprises: a forward keep out zone defined by converging inner and outer walls of a nacelle; an aft keep out zone defined by a containment zone; and an engine control component, at least a portion of which is located between the forward keep out zone and the aft keep out zone, and between the inner and outer walls of the nacelle.

Another embodiment of such a system comprises: a nacelle having an inlet, the inlet defining a gas flow path for intake air of a gas turbine engine, the inlet further defining an annular volume about the gas flow path; and an engine control component, at least a portion of which is located within the annular volume defined by the inlet.

Still another embodiment comprises: a gas turbine engine having a fan operative to provide thrust; and an engine control component located forward of the fan.

Other systems, methods, features and/or advantages of this disclosure will be or may become apparent to one with skill in the art upon examination of the following drawings and detailed description. It is intended that all such additional systems, methods, features and/or advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale. Moreover, in the drawings, like reference numerals designate corresponding parts throughout the several views.

FIG. 1 is a schematic diagram depicting a prior art mounting location of an EEC.

FIG. 2 is a schematic diagram of an embodiment of a system involving an inlet-mounted engine control.

FIG. 3 is a schematic diagram depicting a prior art mounting location and configuration of an EEC.

FIG. 4 is a schematic diagram depicting another embodiment of a system involving an inlet-mounted engine control.

### DETAILED DESCRIPTION

Systems involving inlet-mounted engine controls are provided. In this regard, several embodiments will be described in which a component involved in engine control, e.g., an Electronic Engine Control (EEC), is mounted within an inlet portion of a nacelle that is used to mount a gas turbine engine. In some embodiments, as least a portion of the engine control component is mounted forward of a fan containment zone of the gas turbine engine.

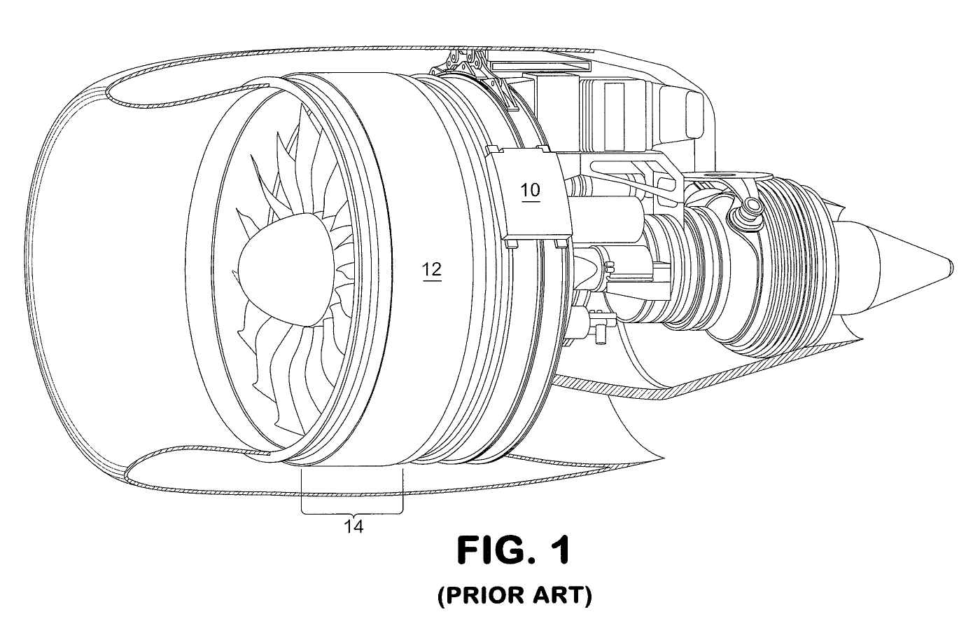

Reference is now made to the schematic diagram of FIG. 1, in which an EEC is mounted as is typically known in the prior art. Specifically, the EEC 10 is mounted to a fan case 12 aft of a fan containment zone 14. Mounting of an EEC in this matter typically is accomplished to provide ground maintenance personnel with access to the EEC via a nacelle door (not shown). Locating the EEC aft of the fan containment zone also potentially prevents damage to the EEC due to catastrophic failure of the blades of the fan. Notably, even though the fan containment zone is designed to prevent radial departure of a liberated fan blade outside the zone, deformation of the material forming the containment zone can occur. Therefore, during catastrophic failure, damage to the EEC could potentially occur. However, locating the EEC aft of the fan containment zone potentially alleviates this concern.

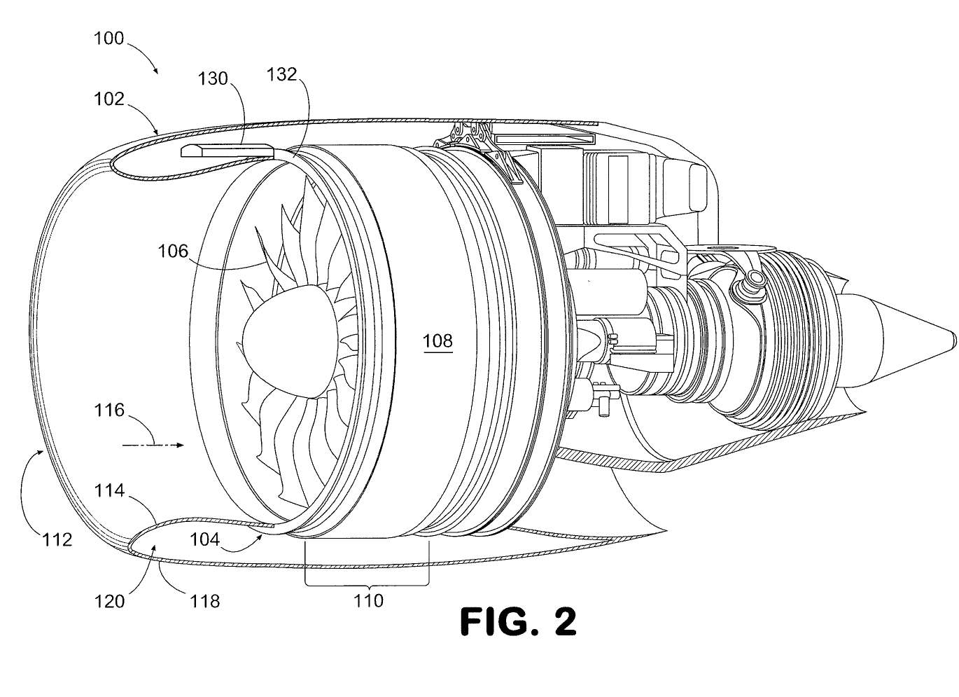

An embodiment of a system involving an inlet-mounted engine control is depicted schematically in FIG. 2. As shown in FIG. 2, system 100 includes a nacelle 102 that mounts a gas turbine engine 104. In this embodiment, the gas turbine engine is a turbofan engine incorporating a fan 106 that is surrounded by a fan case 108. Notably, the fan case includes a designated fan containment zone 110 that is designed to prevent radial departure of a liberated fan blade outside the zone.

Nacelle 102 includes an inlet 112 for the gas turbine engine. Specifically, the inlet incorporates an inner (radially-innermost) wall 114, which defines a gas flow path 116 to the gas turbine engine, and an outer (radially-outermost) wall 118, which defines an exterior of nacelle. A cavity 120, which defines an annular volume about the gas flow path, is formed between the inner wall 114 and the outer wall 118.

In the embodiment of FIG. 2, an engine control component 130 (e.g., an EEC) is mounted within cavity 120. In particular, component 130 is mounted to a front flange 132 of the fan case 108 such that at least a portion of the component 130 is located forward of the fan containment zone. Note that, in this embodiment, the entire component 130 is located forward of the fan containment zone.

Various mounting techniques, such as those involving brackets, can be used to mount the component to the fan case. In other embodiments, an engine control component could be mounted within an inlet cavity without being attached to the fan case.

Placement of an engine control component in an inlet may tend to reduce vibrations experienced by the engine control component. This is because the inlet is more distant from the source of vibration of the gas turbine engine than conventional mounting locations, which are located aft of the fan containment zone. Additionally, availability of unoccupied volume of the inlet may improve cable routing considerations, for example.

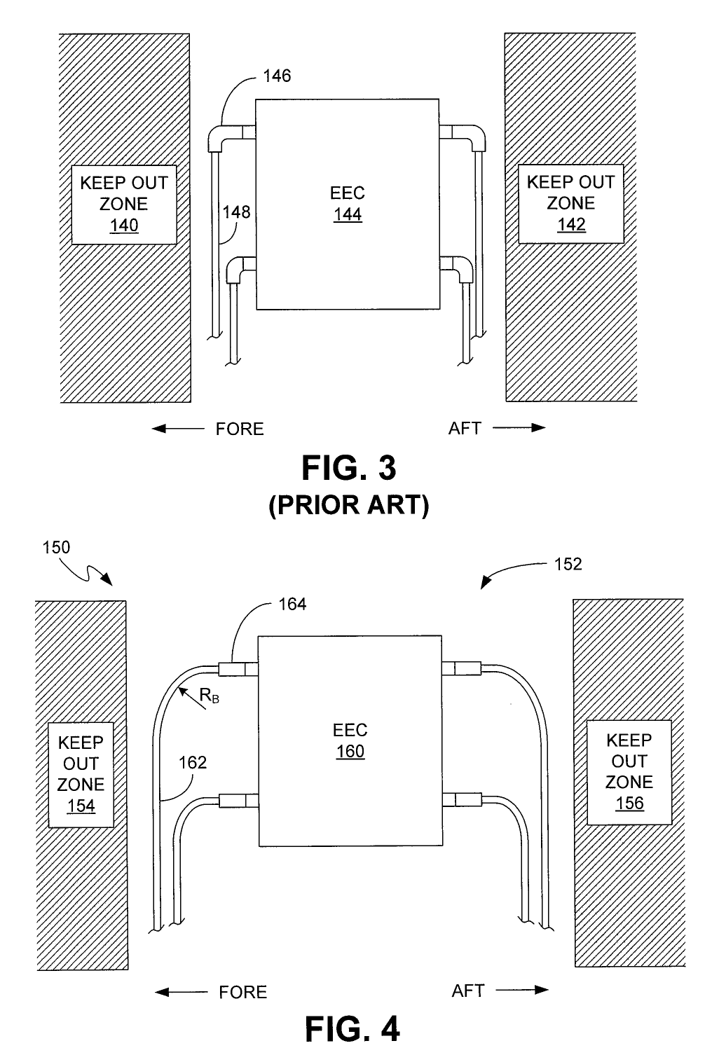

In this regard, a prior art cable-routing configuration is depicted schematically in FIG. 3. As shown in FIG. 3, the forward Keep Out Zone 140 corresponds to a fan containment zone, whereas the aft Keep Out Zone 142 corresponds to a hot section zone in which an engine control component should not be located due to temperature considerations. Notably, the volume defined between the zones 140, 142 is rather restrictive. Specifically, placement of EEC 144 between the zones 140, 142 requires the use angled electrical connectors, e.g., connector 146. In this case, the connectors are 90-degree connectors that enable electrical cables, e.g., cable 148, to be routed between the zones and attached to the EEC.

In contrast, another embodiment of a system involving an inlet-mounted engine control component is depicted schematically in FIG. 4. As shown in FIG. 4, system 150 incorporates a volume 152 in which an engine control component is located. Notably, the volume is much larger than that depicted in FIG. 3. Specifically, the volume 152 is defined by a forward Keep Out Zone 154, which corresponds to an interior barrier of the inlet formed by the converging inner and outer walls of the nacelle, and an aft Keep Out Zone 156, which corresponds to the fan containment zone.

Mounting of an engine control component, e.g., EEC 160, within volume 152 may make it possible to use straight electrical connectors. For example, cable 162 is connected to the EEC 160 by a straight connector 164. This configuration is possible due to the increased available volume for mounting the component with cable runs that exhibit increased bend radii R_{B}. Such cable runs may be more durable than cable runs that use angled connectors, as angled connectors tend to impose more stress on the cables.

It should be emphasized that the above-described embodiments are merely possible examples of implementations set forth for a clear understanding of the principles of this disclosure. Many variations and modifications may be made to the above-described embodiments without departing substantially from the spirit and principles of the disclosure. By way of example, although the above-described embodiments involve the use of turbofan engines, other types of gas turbine engines could be used. All such modifications and variations are intended to be included herein within the scope of this disclosure and protected by the accompanying claims.

1. A system involving an inlet-mounted engine control component comprising:
a forward keep out zone defined by converging inner and outer walls of a nacelle;
an aft keep out zone defined by a containment zone; and
an engine control component, at least a portion of which is located between the forward keep out zone and the aft keep out zone, and between the inner and outer walls of the nacelle.

2. The system of claim 1, wherein:
the system further comprises a fan casing; and
the engine control component is mounted to the fan casing.

3. The system of claim 2, wherein:
the fan casing has a forward flange; and
the engine control component is attached to the forward flange of the fan casing.

4. The system of claim 1, wherein:
the system further comprises an electrical cable having a straight connector attached thereto; and
the electrical cable is attached to the engine control component by the straight electrical connector.

5. The system of claim 1, wherein the engine control component is an electronic engine control (EEC).

6. The system of claim 6, wherein the containment zone is a fan containment zone.

7. The system of claim 1, further comprising:
the nacelle; and
a gas turbine engine mounted to the nacelle.

8. The system of claim 7, wherein the gas turbine engine is a turbofan.

9. The system of claim 1, wherein an entirety of the engine control component is located between the forward keep out zone and the aft keep out zone.

10. The system of claim 1, wherein an entirety of the engine control component is located between the inner and outer walls of the nacelle.

11. A system involving an inlet-mounted engine control component comprising:
a nacelle having an inlet, the inlet defining a gas flow path for intake air of a gas turbine engine, the inlet further defining an annular volume about the gas flow path; and
an engine control component, at least a portion of which is located within the annular volume defined by the inlet.

12. The system of claim 11, wherein the annular volume is defined by an inner wall and an outer wall.

13. The system of claim 12, wherein the inner wall and the outer wall converge to form a leading edge of the inlet.

14. The system of claim 11, wherein the annular volume is further defined by an aft keep out zone corresponding to a containment zone.

15. The system of claim 14, wherein the aft containment zone is a fan containment zone.

16. The system of claim 11, further comprising a gas turbine engine mounted to the nacelle.

17. A system involving an inlet-mounted engine control component comprising:
a gas turbine engine having a fan operative to provide thrust; and
an engine control component located forward of the fan.

18. The system of claim 17, wherein:
the system further comprises a nacelle mounting the gas turbine engine, the nacelle having an inlet operative to direct intake air to the gas turbine engine, the inlet further defining a cavity; and
at least a portion of the engine control component is located within the cavity.

19. The system of claim 18, wherein the cavity is located between a radially-innermost wall and a radially-outermost wall of the nacelle, and aft of a leading edge of the inlet.

20. The system of claim 18, wherein the cavity is an annular-shaped cavity.
